(19) United States
(12) Patent Application Publication
(10) Pub. No.: US 2006/0235725 A1
(43) Pub. Date: Oct. 19, 2006

(54) Method for utilization of computer-assisted diagnosis tools

(76) Inventors: Martin Kleen, Furth (DE); Norbert Rahn, Forchheim (DE); Jan Boese, Eckental (DE)

Correspondence Address: SCHIFF HARDIN, LLP;PATENT DEPARTMENT, 6600 SEARS TOWER, CHICAGO, IL, 60606-6473, US

(21) Appl. No.: 11/107,115

(22) Filed: Apr. 15, 2005

(51) Int. Cl. G06Q 10/00

(52) U.S. Cl. 705/2

(57) ABSTRACT

A computer-assisted diagnosis method and system for assisting doctors in diagnosis of patient aliments includes providing the computer-assisted diagnosis algorithm at a central location and providing client software at a doctor's or user's location for communication with the central location. Image data sets are communicated from the doctor's or user's client software to the computer-assisted diagnosis software at the central location so that a diagnosis can be performed by the computer-assisted diagnosis algorithm. The diagnosis of the diagnosis algorithm is provided to the user or doctor which is incorporated in the doctor's analysis to provide a final diagnosis to the patient. The final diagnosis is provided back to the central location of the computer-assisted diagnosis algorithm for improvement of the algorithm.

### BACKGROUND OF THE INVENTION

1. Field of the Invention

The present invention relates generally to a method for computer-assisted diagnosis of medical problems, and more particularly to a method for utilization of computer-assisted diagnosis tools in diagnosing illnesses, injuries and maladies.

2. Description of the Related Art

Computer-assisted diagnosis (CAD) systems can be helpful to a doctor, for example, in locating pathological changes in patients in the large quantities of data that result from computer tomography, in tracking subtle changes in x-ray images, such as in mammography, or in marking suspicious areas in complex structures such as in x-ray images of the thorax.

Computer aided diagnosis algorithms are trained and validated and then are delivered to customers for regular use in this invariable state. However, computer-assisted diagnosis algorithms are used in comparable systems throughout the world. Enormous quantities of data are generated worldwide and are automatically processed by the diagnosis algorithms without utilization of the experience that can be gained from the algorithms that have been created.

An effort to implement on-site automatic learning algorithms for computer-assisted diagnosis in an installed system has run into many problems. In particular, the user of such algorithms does not have a high enough frequency of use to effectively train the algorithm for more effective use.

The on-site installation of computer-assisted diagnosis tools does not consider the frequency of use for the system since a heavy user pays the same price for the system as an occasional user. The occasional user of a computer-assisted diagnosis system does not utilize the system often enough to justify its purchase and so usually does not purchase such systems.

Existing computer-assisted diagnosis tools are sold at a single price and are distributed to the end users without utilization of operating feedback from the user to the developer of the system.

### SUMMARY OF THE INVENTION

In a first aspect of the present invention, a computer-assisted diagnosis system is provided at a central location and is operated from a vendor or service provider site. End users utilize the centrally located computer-assisted diagnosis tool through a secure dispatch of data to be diagnosed to the site where the computer-assisted diagnosis system is operating.

The present invention provides a method and system for computer-assisted diagnosis wherein a computer-assisted diagnosis algorithm operates at a central location and is in communication with a local installation of software for interaction with the computer-assisted diagnosis algorithm. Communication between the central location computer-assisted diagnosis algorithm and the local software, which is local to the end user, can include transmission of either an entire image data or only metadata. Charges for use of the computer-assisted diagnosis algorithm are based on use and charges for the use are made depending on at least one of several different criteria

### BRIEF DESCRIPTION OF THE DRAWINGS

FIG. 1 is a flowchart of a conventional workflow for diagnosis without utilization of a computer-assisted diagnosis system;

FIG. 2 is a workflow diagram of a diagnosis using a conventional computer-assisted diagnosis system; and

FIG. 3 is a workflow diagram of a diagnosis utilizing a computer-assisted diagnosis system and method according to the principles of the present invention.

### DETAILED DESCRIPTION OF THE PREFERRED EMBODIMENTS

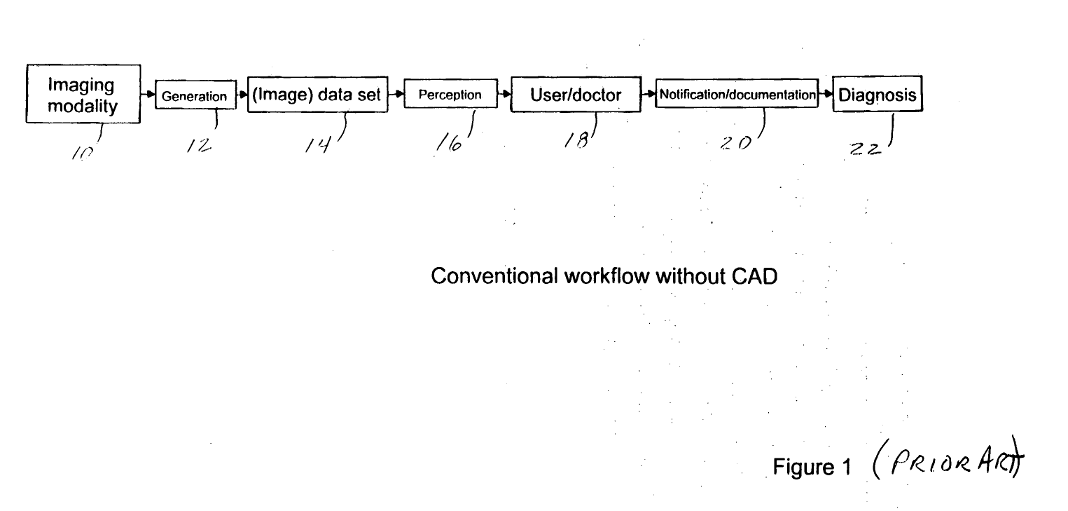

FIG. 1 is a conventional workflow for diagnosis by a doctor of an ailment, illness or injury without utilizing a computer-assisted diagnosis system. The process begins with the use of an imaging modality or imaging apparatus in step 10. The use of the imaging apparatus 10 generates an image 12 and one of more images are provided as an image dataset 14. The perception of the images 16 is obtained by examination of the images by a user and/or a doctor 18. Documentation of the doctor's findings and notification of the patient at 20 results in a diagnosis 22 of the patient. Thus, an imaging system is utilized to assist the doctor in obtaining a diagnosis of a patient.

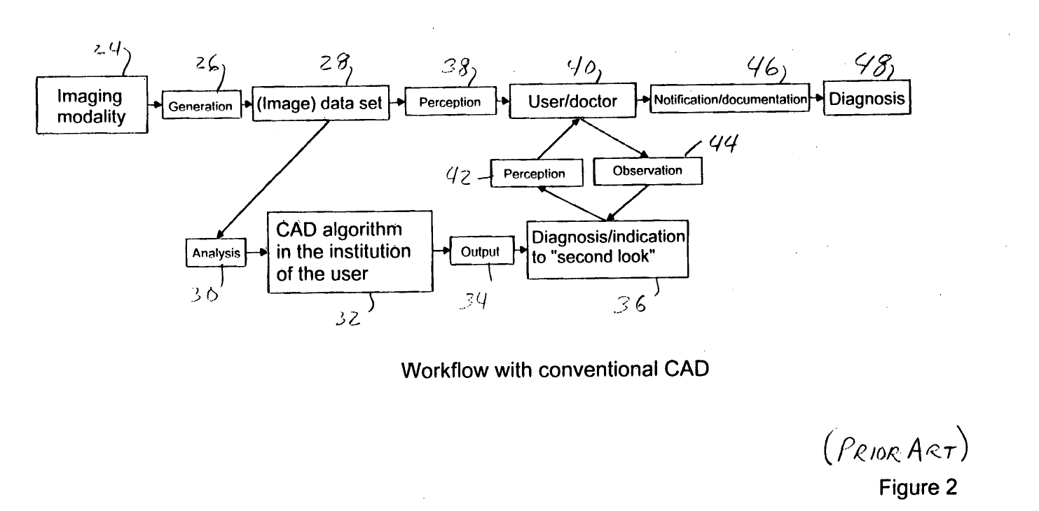

Computer-assisted diagnosis systems can be incorporated into the diagnosis process as shown in FIG. 2. The computer-assisted diagnosis begins with utilization of an imaging modality or imaging system 24 for generation 26 of an image data set 28. The image data set 28 is provided for analysis 30 by a computer-assisted diagnosis algorithm that is located in the institution of the user 32. The operation of the computer-assisted diagnosis algorithm results in an output of the diagnosis system 34 and this output provides either a preliminary diagnosis or an indication to take a second look at the data at 36. The data may also be examined directly at 38 by a user or a doctor 40. The user or doctor 40 interacts with the output preliminary diagnosis or indication to take a second look 36 through the use of perception 42 of the doctor who provides an observation 44 as to the validity of the preliminary diagnosis 36 of the computer-assisted diagnosis algorithm 32. The doctor then provides a notification and/or documentation 46 of the findings which result in a final diagnosis 48.

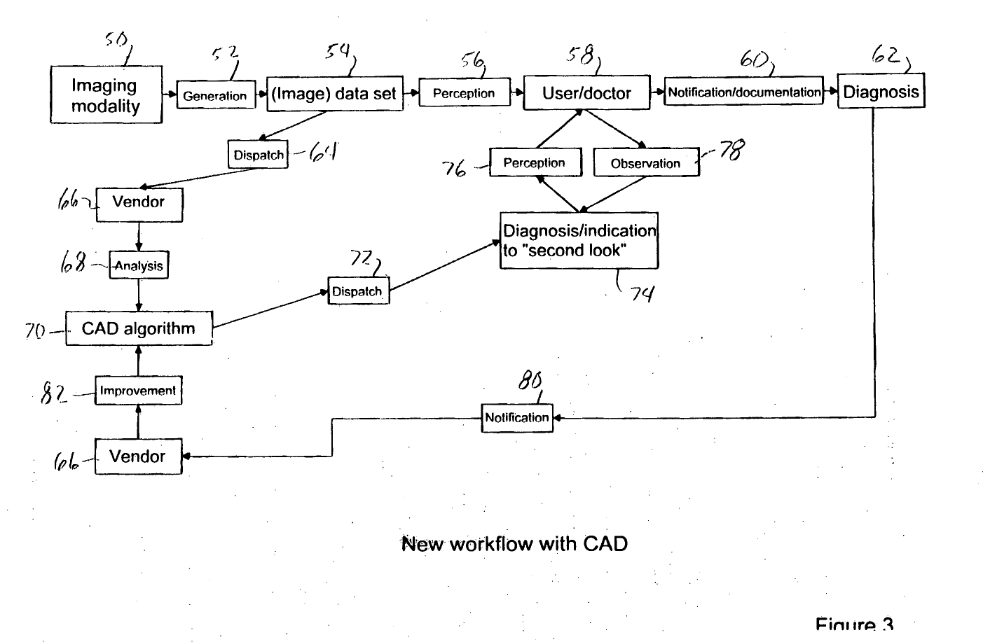

With reference to FIG. 3, an exemplary embodiment of the present method provides that an imaging modality or system 50 is utilized for generation 52 of an image data set 54. The imaging system can be a computed tomography system, x-ray imaging system, magnetic resonance imaging system, ultrasound imaging system, optical imaging system, PET imaging, gamma imaging and all other imaging systems whether within the foregoing list or representing an additional imaging system. The present invention is not limited to imaging systems but may be applied to data from other diagnosis tools as well. All such diagnostic data is included within the term image data set for purposes of the present invention. As before, the perception 56 of a user or doctor 58 is documented and provided in a notification 60 to provide a preliminary diagnosis 62. However, according to the principles of the present invention, the image data set or at least a portion of the data 54 is dispatched at 64 to a vendor site 66 for analysis 68. The analysis is performed on a computer-assisted diagnosis system utilizing a computer-assisted diagnosis algorithm 70. The computer-assisted diagnosis algorithm is resident on the equipment of the vendor at a central location, such as a server on a network. The results of running the computer-assisted diagnosis algorithm are dispatched 72 as a preliminary diagnosis or an indication to take a second look 74 which is provided to the user or doctor 58 for utilization of the doctor's perception 76 of the preliminary diagnosis and the doctor's observations 78 are provided as feedback on the preliminary diagnosis 74.

When the doctor 58 has completed the analysis and has generated a final diagnosis 62 for the patient a notification 80 of the final diagnosis 62 is provided back to the vendor 66 for generation of improvements 82 in the computer-assisted diagnosis algorithm 70.

The computer-assisted diagnosis algorithm 70 is provided at a central location which may be the location of the vendor 66 or of a service provider of the vendor. The communication between the central location of the computer-assisted diagnosis algorithm 70 and the imaging modality 50 is provided by installation of software on the end user or doctor's system which enables a secure dispatch of the data to be diagnosed to the algorithm 70. The installation of this local software component, which may be termed client software, may in some embodiments be initially provided without cost to the end user or doctor or at a very low cost to the end user or doctor.

The end user or doctor here is a customer who has the computer-assisted diagnosis client software installed on their system or who has use of the system or who instructs someone who has use of the system. When the customer desires to utilize the computer-assisted diagnosis system, the computer-assisted diagnosis client software opens a connection, which is preferably a secure connection, with the computer-assisted diagnosis server software at the central vendor location. This connection can be provided via a telephone connection, via the Internet, or via local area networks, wide area networks or other types of network or direct communication connection, whether wired or wireless. Either the entire image data set can be dispatched by the client software for computer-assisted diagnosis or only selected metadata may be dispatched by the client software to the server software if such metadata is sufficient to suitably describe the original data for diagnosis. The computer-assisted diagnosis server software performs a computer-assisted diagnosis of the image data or metadata utilizing data banks of already conducted diagnoses. The result of the computer-assisted diagnosis is provided as a dispatch to the customer's system, such as through the computer-assisted diagnosis client software, by the computer-assisted diagnosis server software.

For purposes of the present invention, client software refers to any software capable of communication to a centrally located diagnosis algorithm, including browser software, file transfer software, email software and the like.

According to one aspect, the customer is charged for use of the computer-assisted diagnosis algorithm by the vendor. The charges for utilization of the diagnosis software can be based upon a variety of criteria. In one embodiment, the charge is based upon the volume of data to be analyzed. In another embodiment, the charge is based upon the run time of the diagnosis algorithm. In yet a further embodiment, the charge is based upon the existence of a positive diagnosis result or on the relevance of the diagnosis result to the final diagnosis. The charges can be based on other criteria as well, or on a combination of two or more criteria.

The payments for the charges for use of the computer-assisted diagnosis system may be conventional payments with money, credit, wire transfer or other standard payment arrangements. According to another embodiment, all or part of the payment for utilization of the computer-assisted diagnosis system may be provided via authorization by the customer to the vendor to use the image information sent by the customer for further improvement of the diagnosis algorithm. In particular, in a preferred embodiment, an agreement is provided that payment will only be completed when a final, real diagnosis for the image has been supplied from the customer to the vendor in addition to the image data that was supplied by the customer (the doctor) to the vendor. The final real diagnosis confirmed by a doctor or medical specialist is seen as a gold standard against which a computer-assisted diagnosis is measured.

The payment in the form of authorization to utilize a final diagnosis for improvement of the diagnosis algorithm can be accorded a higher value when the diagnosis is confirmed by a specialist doctor and an even higher value when the diagnosis is confirmed by multiple specialist doctors. An even higher value may be accorded a payment for a diagnosis confirmed by histological diagnosis from a biopsy. Other value assignments may be provided as well, within the scope of this invention.

Thus, the present invention utilizes the data set and final diagnosis pairs as a form of currency and via such pairs, a continuing improvement and optimization can be provided in terms of the capability of the diagnosis algorithm. Instead of being delivered to the customer as a finished diagnosis algorithm in invariable form, the present computer-assisted diagnosis algorithm remains at the central vendor location and is continuously improved through the aid of data sets arriving from other customers. A customer can therefore pay a relatively inexpensive price for a computer-assisted diagnosis capability. The computer-assisted diagnosis capability utilizes a data set and an associated final diagnosis which is obtained in the customer's work sequence anyway. The customer is motivated to utilize and provide the data set and final diagnosis to the vendor for improvement of the diagnosis algorithm based upon the significant financial savings which is available to the customer as a result of the arrangement for non-financial payment or non-financial partial payment.

Since the diagnosis algorithm is continuously being improved by the data set and final diagnosis pairs received from the customer and other customers, the quality of the diagnosis algorithm is improved in a very short time and so it is possible to provide a far better diagnosis utilizing the present system and method than is possible with conventional, one-time validated and trained algorithms.

As an alternative embodiment, the customer or user can purchase a private installation of the improved algorithm that results from the feedback of data from other customers for installation in the user's local environment. This installation will generally be at a significant financial expenditure by the user and may include maintenance costs as well. According to this embodiment, the diagnosis algorithm is current with the improvements as of the time of purchase and is installed on the user's or customer's computer for execution with the user's or customer's data. The user or customer may pay for maintenance of the diagnosis algorithm and thereby receive upgrades to the diagnosis algorithm which are further trained and improved by input received from many users providing data to the vendor location.

Thus, in the preferred embodiment a customer can obtain the use of a computer-assisted diagnosis algorithm with little financial investment and only pay for actual use of the algorithm. The payment to the customer for the use of the algorithm may be by an increased value produced for the customer in the work sequence of producing a diagnosis and this increased value can be passed on to the customer's patient without further costs. An advantage of the present method and system is that the software is maintained and updated centrally without cost to the customer and can be implemented centrally by or on behalf of the vendor in a simple and cost-effective manner.

The computer-assisted diagnosis algorithm may be continuously upgraded to the latest state-of-the-art system and the accuracy of the diagnosis algorithm may be continuously improved through feedback received from final diagnosis and data pairs received from the customers. The database which forms the basis of training the algorithm continuously grows and is generally significantly larger than would be available with conventional training methods.

Thus, there is shown and described a method and system for computer-assisted diagnosis using a centrally located diagnosis algorithm in communication with a client software component that is local to the customer. According to the preferred embodiment, payment for the use of the diagnosis algorithm may be provided by feedback of the final diagnosis and the data set so that the centrally installed computer-assisted diagnosis algorithm may be improved by comparison between the final diagnosis and the diagnosis provided by the computer-assisted diagnosis algorithm.

A computer-assisted diagnosis method and system for assisting doctors in diagnosis of patient aliments includes providing the computer-assisted diagnosis algorithm at a central location and providing client software at a doctor's or user's location for communication with the central location. Image data sets are communicated from the doctor's or user's client software to the computer-assisted diagnosis software at the central location so that a diagnosis can be performed by the computer-assisted diagnosis algorithm. The diagnosis of the diagnosis algorithm is provided to the user or doctor which is incorporated in the doctor's analysis to provide a final diagnosis to the patient. The final diagnosis is provided back to the central location of the computer-assisted diagnosis algorithm for improvement of the algorithm.

Although other modifications and changes may be suggested by those skilled in the art, it is the intention of the inventors to embody within the patent warranted hereon all changes and modifications as reasonably and properly come within the scope of their contribution to the art.

We claim:

1. A method for computer-assisted diagnosis, comprising the steps of:
from a customer an image data set generated by a medical imaging system;
performing a computer-assisted diagnosis on the image data set using centrally located computer-assisted diagnosis algorithm to generate a preliminary diagnosis;
communicating the preliminary diagnosis to the customer;
receiving payment from the customer for the preliminary diagnosis.

2. A method as claimed in claim 1, wherein said payment is in a form of a final diagnosis accorded the image data set, said final diagnosis being communicated from the customer.

3. A method as claimed in claim 1, further comprising improving the computer-assisted diagnosis algorithm by a final diagnosis received from the user.

4. A method as claimed in claim 1, wherein said payment is at least partly by financial payment.

5. A method as claimed in claim 1, further comprising the step of:
providing client software to the customer, said client software being operable on a computer to communicate the image data set to the central computer-assisted diagnosis algorithm.

6. A method as claimed in claim 1, wherein the central computer-assisted diagnosis algorithm is on a server computer.

7. A method as claimed in claim 1, wherein said step of receiving the image data set is via a network connection.
